(19) United States
(12) Patent Application Publication
(10) Pub. No.: US 2024/0246464 A1
(43) Pub. Date: Jul. 25, 2024

(54) Car Seat Heating Pad Device

(71) Applicant: Preston Froedge, Seymour, IN (US)

(72) Inventor: Preston Froedge, Seymour, IN (US)

(21) Appl. No.: 18/187,735

(22) Filed: Mar. 22, 2023

Related U.S. Application Data
(60) Provisional application No. 63/439,912, filed on Jan. 19, 2023.

(51) Int. Cl. B60N 2/56; H05B 1/02; H05B 3/34

(52) U.S. Cl. CPC B60N 2/5685; H05B 1/0272; H05B 3/342; H05B 1/0202; H05B 2203/005

(57) ABSTRACT

The present invention relates to a car seat heating pad device that can be removably used in an infant/child car seat to provide a heated seat experience. The device can be secured to the car seat via at least one fastener that may be in the form of a clip or a clamp. The temperature of a heating pad of the device placed within the car seat can be controlled via a remote connected to the power cord. The power cord allows the device to receive power from being plugged into the cigarette lighter or other structure within a vehicle.

### CROSS-REFERENCE TO RELATED APPLICATION

The present application claims priority to, and the benefit of, U.S. Provisional Application No. 63/439,912, which was filed on Jan. 19, 2023, and is incorporated herein by reference in its entirety.

### FIELD OF THE INVENTION

The present invention relates generally to the field of heating pads for vehicle seats. More specifically, the present invention relates to a car seat heating pad device that can be removably used in an infant/child car seat. The device can be secured to the car seat via at least one fastener that may be in the form of a clip or a clamp. The temperature of a heating pad of the device placed within the car seat can be controlled via a remote connected to the power cord. The power cord allows the device to receive power from being plugged into the cigarette lighter or other structure within a vehicle. Accordingly, the present disclosure makes specific reference thereto. Nonetheless, it is to be appreciated that aspects of the present invention are also equally applicable to other like applications, devices, and methods of manufacture.

### BACKGROUND

Many vehicles today are equipped with heated seats. However, infant car seats are not equipped with heating capabilities. In addition, placing an infant car seat on a heated seat does not allow heat from the heated seat to be transferred to the car seat due to the thickness of the car seat.

Therefore, there exists a long-felt need in the art for a device that can be used to heat the seat of an infant car seat. There also exists a long-felt need in the art for a car seat heating pad device that can be easily placed within any infant car seat to provide heat to an infant within the seat. Further, there exists a long-felt need in the art for a car seat heating pad device that can be easily placed within any infant car seat to provide heat to an infant within the seat, wherein the device is easily removable from the car seat.

The subject matter disclosed and claimed herein, in one embodiment thereof, comprises a car seat heating pad device. The device is primarily comprised of at least one heating pad with at least one heating element, at least one power cord, at least one remote with at least one button, and at least one fastener. The heating pad of the device can be placed within an infant car seat to provide a heated seat experience to an infant/child within the seat. The device can be secured to the car seat via at least one fastener that may be in the form of a clip or a clamp. The temperature of the heating pad can be controlled via a remote connected to the power cord. The power cord allows the device to receive power from being plugged into the cigarette lighter or other structure within a vehicle.

In this manner, the car seat heating pad device of the present invention accomplishes all the foregoing objectives and provides a car seat heating pad device. During use, the device can be easily placed within any infant car seat to provide heat to an infant within the seat. Further, the device is easily removable from the car seat.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a car seat heating pad device primarily comprised of at least one heating pad with at least one heating element, at least one power cord, at least one remote with at least one button, and at least one fastener. The heating pad of the device may be any shape, size, and configuration of heating pad known in the art that allows the device to be placed in any child or infant car seat known in the art. In one embodiment, the device is comprised of a plurality of heating pads connected by at least one flexible connector.

The pad is comprised of at least one heating element that is preferably at least one heating coil. The heating element preferably has a plurality of heating levels. The heating element is preferably comprised of an internal limiter that prevents the element from overheating during use.

The heating levels (as well as the power of the device) can be controlled via at least one remote located on the power cord. The remote may be comprised of at least one button that allows a user to configure the heating levels of the heating element. The power cord also supplies power to the battery, which in turn supplies power to the heating element via at least one electrical wire. The power cord is preferably comprised of a cigarette lighter power cord that allows the cord to be powered by a cigarette outlet of a vehicle.

The device is preferably secured to a car seat via at least one fastener. In one embodiment, the fastener is comprised of an upside-down u-shaped clamp. In another embodiment, the fastener may be in the form of a clip. However, the fastener may be any fastening method or structure known in the art that can attach to any portion of a car seat.

Accordingly, the car seat heating pad device of the present invention is particularly advantageous as it provides a car seat heating pad device. During use, the device can be easily placed within any infant car seat to provide heat to an infant within the seat. Further, the device is easily removable from the car seat. In this manner, the car seat heating pad device provides a solution to heating an infant car seat.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a car seat heating pad device of the present invention in accordance with the disclosed architecture;

FIG. 2 illustrates a top perspective view of one potential embodiment of a car seat heating pad device of the present invention while placed within a car seat in accordance with the disclosed architecture; and

FIG. 3 illustrates a perspective view of one potential embodiment of a car seat heating pad device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to heat the seat of an infant car seat. There also exists a long-felt need in the art for a car seat heating pad device that can be easily placed within any infant car seat to provide heat to an infant within the seat. Further, there exists a long-felt need in the art for a car seat heating pad device that can be easily placed within any infant car seat to provide heat to an infant within the seat, wherein the device is easily removable from the car seat.

The present invention, in one exemplary embodiment, is comprised of a car seat heating pad device primarily comprised of at least one heating pad with at least one heating element, at least one power cord, at least one remote with at least one button, and at least one fastener. The heating pad of the device may be any shape, size, and configuration of heating pad known in the art that allows the device to be placed in any child or infant car seat known in the art. In one embodiment, the device is comprised of a plurality of heating pads connected by at least one flexible connector. The pad is also comprised of at least one heating element that is preferably at least one heating coil with a plurality of heating levels. The heating element is preferably comprised of an internal limiter that prevents the element from overheating during use.

The heating levels (as well as the power of the device) can be controlled via at least one remote located on the power cord. The remote may be comprised of at least one button that allows a user to configure the heating levels of the heating element. The power cord also supplies power to the battery, which in turn supplies power to the heating element via at least one electrical wire. The power cord is preferably comprised of a cigarette lighter power cord that allows the cord to be powered by a cigarette outlet of a vehicle.

The device is preferably secured to a car seat via at least one fastener. In one embodiment, the fastener is comprised of an upside-down u-shaped clamp. In another embodiment, the fastener may be in the form of a clip. However, the fastener may be any fastening method or structure known in the art that can attach to any portion of a car seat.

Accordingly, the car seat heating pad device of the present invention is particularly advantageous as it provides a car seat heating pad device. During use, the device can be easily placed within any infant car seat to provide heat to an infant within the seat. Further, the device is easily removable from the car seat. In this manner, the car seat heating pad device provides a solution to heating an infant car seat.

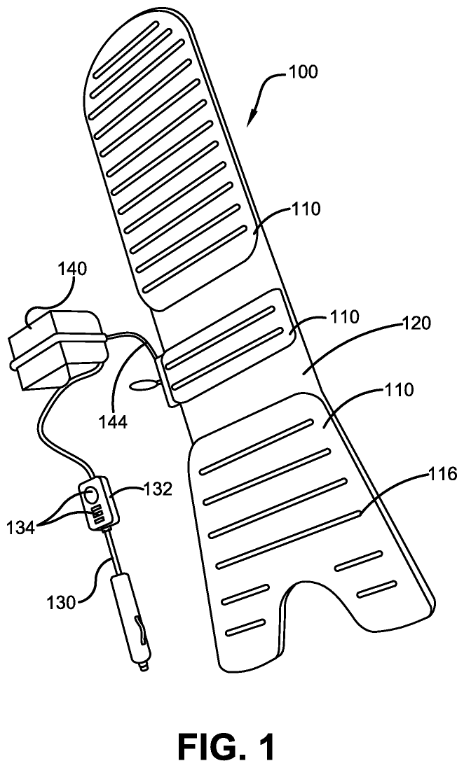

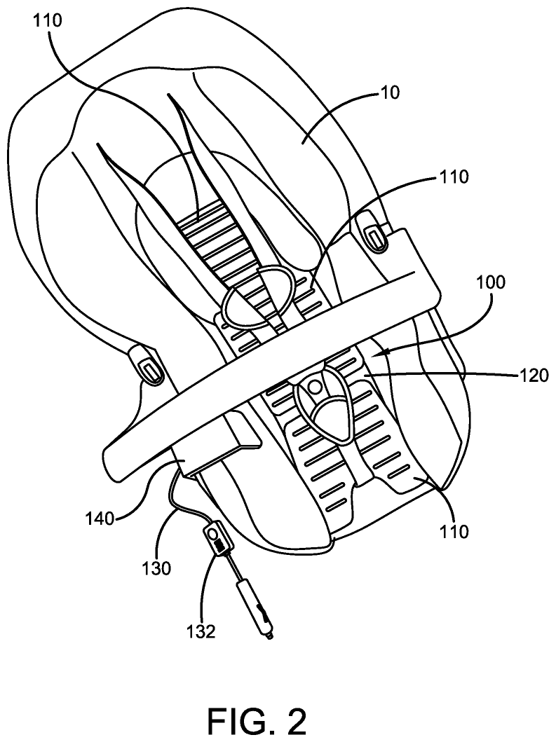

Referring initially to the drawings, FIG. 1 illustrates a perspective view of one potential embodiment of a car seat heating pad device 100 of the present invention in accordance with the disclosed architecture. The device 100 is primarily comprised of at least one heating pad 110 with at least one heating element 112, at least one power cord 120, at least one remote 132 with at least one button 134, and at least one fastener 140. The heating pad 110 of the device 100 may be any shape, size, and configuration of heating pad known in the art that allows the device 100 to be placed in any child or infant car seat 10 known in the art, as seen in FIG. 2. In one embodiment, the device 100 is comprised of a plurality of heating pads 110 connected by at least one connector 120. The connector 120 is preferably comprised of a flexible material such as, but not limited to, fabric that allows the pads 110 and device 100 to conform to the shape of a car seat 10.

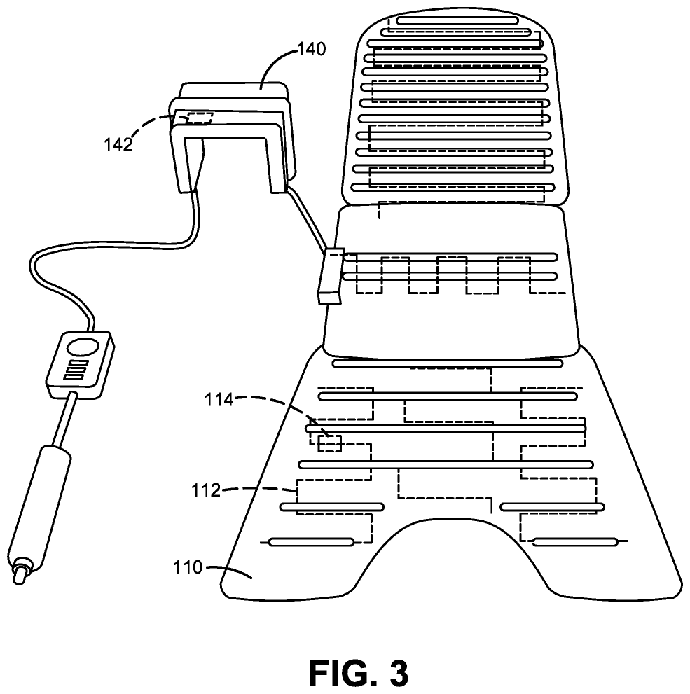

The pad 110 is comprised of at least one heating element 112, as seen in FIG. 3. The heating element 112 may be any type of heating element known in the art. This includes, but is not limited to, at least one heating coil. In one embodiment, the pad 110 is comprised of at least one protrusion 116 that allows air to circulate between a child's body and the pad 110 during use to prevent overheating.

The heating element 112 preferably has a plurality of heating levels. Said heating levels may include low, medium, and high levels. Alternatively, the heating levels may be in the form of specific temperatures and/or temperature ranges. The heating element 112 is preferably comprised of an internal limiter 114 that prevents the element 112 from overheating during use. If a temperature threshold value of the limiter 114 is exceeded, the limiter 114 will automatically shut off power to the heating element 114.

The heating levels (as well as the power of the device 100) can be controlled via at least one remote 132 located on the power cord 130. The remote 132 may be comprised of at least one button 134 that allows a user to configure the heating levels of the heating element 112.

The power cord 130 supplies power to the battery 142, which in turn supplies power to the heating element 112 via at least one electrical wire 144. The power cord 130 is preferably comprised of a cigarette lighter power cord that allows the cord 130 to be powered by a cigarette outlet of a vehicle. In other embodiments, the power cord 130 may be any type of USB power cord, a 110v/240v power cord, or any other type and configuration of power cord known in the art.

The battery 142 may be a disposable battery 142 or a rechargeable battery 142 in the form of an alkaline, nickel-cadmium, nickel-metal hydride battery 142, etc., such as any 3V-12volts DC battery 142 or other conventional battery 142 such as A, AA, AAA, etc., that supplies power to the device 100. Throughout this specification the terms “battery” and “batteries” may be used interchangeably to refer to one or more wet or dry cells or batteries 142 of cells in which chemical energy is converted into electricity and used as a source of DC power. References to recharging or replacing batteries 142 may refer to recharging or replacing individual cells, individual batteries 142 of cells, or a package of multiple battery cells as is appropriate for any given battery 142 technology that may be used.

The device 100 is preferably secured to a car seat 10 via at least one fastener 140. In one embodiment, the fastener 140 is comprised of an upside-down u-shaped clamp. In another embodiment, the fastener 140 may be in the form of a clip. However, the fastener 140 may be any fastening method or structure known in the art that can attach to any portion of a car seat 10. In one embodiment, the fastener 140 may house the battery 142.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “car seat heating pad device” and “device” are interchangeable and refer to the car seat heating pad device 100 of the present invention.

Notwithstanding the foregoing, the car seat heating pad device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the car seat heating pad device 100 as shown in the FIGS. are for illustrative purposes only, and that many other sizes and shapes of the car seat heating pad device 100 are well within the scope of the present disclosure. Although the dimensions of the car seat heating pad device 100 are important design parameters for user convenience, the car seat heating pad device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A car seat heating pad device comprising:
a heating pad;
a heating element;
a fastener;
a power cord comprised of a remote; and
a battery.

2. The car seat heating pad device of claim 1, wherein the heating element is comprised of a heating coil.

3. The car seat heating pad device of claim 1, wherein the fastener is comprised of a clamp.

4. The car seat heating pad device of claim 1, wherein the fastener is comprised of a clip.

5. The car seat heating pad device of claim 1, wherein the heating element is comprised of a first heating level and a second heating level.

6. The car seat heating pad device of claim 1, wherein the battery is in electrical communication with the heating element via a wire.

7. A car seat heating pad device comprising:
a heating pad;
a heating element having a limiter;
a fastener;
a power cord;
a remote; and
a battery.

8. The car seat heating pad device of claim 7, wherein the heating pad is comprised of a protrusion.

9. The car seat heating pad device of claim 7, wherein the limiter is comprised of a temperature threshold.

10. The car seat heating pad device of claim 9, wherein the limiter shuts off the heating element if the temperature threshold is exceeded.

11. The car seat heating pad device of claim 7, wherein the heating element is comprised of a first heating level and a second heating level.

12. The car seat heating pad device of claim 11, wherein the first heating level and the second heating level can be selected by a button of the remote.

13. The car seat heating pad device of claim 7, wherein the battery is in electrical communication with the heating element via a wire.

14. A car seat heating pad device comprising:
a first heating pad;
a first heating element;
a second heating pad;
a second heating element;
a connector attached to the first heating pad and to the second heating pad;
a fastener;
a power cord;
a remote having a button; and
a battery.

15. The car seat heating pad device of claim 14, wherein the power cord is comprised of a USB power cord.

16. The car seat heating pad device of claim 14, wherein the power cord is comprised of a cigarette lighter power cord.

17. The car seat heating pad device of claim 14, wherein the power cord is comprised of a 110v or 240v power cord.

18. The car seat heating pad device of claim 14, wherein the connector is comprised of a flexible material.

19. The car seat heating pad device of claim 18, wherein the flexible material is comprised of a fabric material.

20. The car seat heating pad device of claim 14, wherein the battery is positioned in the fastener.
